(19) United States
(12) Patent Application Publication
(10) Pub. No.: US 2025/0377566 A1
(43) Pub. Date: Dec. 11, 2025

(54) DISPLAY DEVICE

(71) Applicant: Japan Display Inc., Tokyo (JP)

(72) Inventor: Junko NAGASAWA, Tokyo (JP)

(21) Appl. No.: 19/192,832

(22) Filed: Apr. 29, 2025

(30) Foreign Application Priority Data
Jun. 6, 2024 (JP) 2024-092301

(51) Int. Cl. G02F 1/1347; G02F 1/1334; G02F 1/1337

(52) U.S. Cl. CPC G02F 1/13471; G02F 1/1334; G02F 1/133707; G02F 2202/28

(57) ABSTRACT

According to one embodiment, a display device includes a display panel for displaying images, a transparent substrate having a main surface opposing the display panel and a first side surface connected to the main surface, a light source unit for irradiating light toward the first side surface, and an adhesive layer that adheres the display panel and the transparent substrate and has a refractive index lower than that of the transparent substrate.

### CROSS-REFERENCE TO RELATED APPLICATIONS

This application is based upon and claims the benefit of priority from Japanese Patent Application No. 2024-092301, filed Jun. 6, 2024, the entire contents of which are incorporated herein by reference.

### FIELD

Embodiments described herein relate generally to a display device.

### BACKGROUND

In recent years, display devices with display panels including polymer dispersed liquid crystal (PDLC) layers and light sources have been proposed. Polymer dispersed liquid crystal layers can switch between a scattering state, in which light is scattered, and a transparent state, in which light is transmitted.

The display device can display images in the scattering state. When the display panel is switched to the transparent state, the user can visually recognize the background through the display panel.

### BRIEF DESCRIPTION OF THE DRAWINGS

FIG. 1 is a diagram showing a configuration example of a display device according to the first embodiment.

FIG. 2 is a cross-sectional view schematically showing a configuration example of a display panel shown in FIG. 1.

FIG. 3 is an exploded perspective view showing a main part of the display device according to the first embodiment

FIG. 4 is a plan view schematically showing the display device illustrated in FIG. 3.

FIG. 5 is a schematic cross-sectional view taken along line V-V shown in FIG. 4.

FIG. 6 is a schematic cross-sectional view taken along line VI-VI shown in FIG. 4.

FIG. 7 is a schematic partial cross-sectional view showing a display device according to the second embodiment.

FIG. 8 is a plan view schematically showing a display device according to the third embodiment.

FIG. 9 is a schematic cross-sectional view taken along line IX-IX shown in FIG. 8.

FIG. 10 is a schematic cross-sectional view taken along line X-X shown in FIG. 8.

FIG. 11 is a schematic partial cross-sectional view showing a display device according to the second embodiment.

### DETAILED DESCRIPTION

In general, according to one embodiment, a display device comprises a display panel which displays images, a transparent substrate including a main surface opposing the display panel and a first side surface connected to the main surface, a light source unit which irradiates light toward the first side surface, and an adhesive layer which adheres the display panel and the transparent substrate to each other and has a refractive index lower than that of the transparent substrate.

With configurations such as described above, it is possible to provide a display device which can suppress the decrease in display quality.

Embodiments will be described hereinafter with reference to the accompanying drawings. Note that the disclosure is merely an example, and proper changes within the spirit of the invention, which are easily conceivable by a skilled person, are included in the scope of the invention as a matter of course.

In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Note that, in order to make the descriptions more easily understandable, some of the drawings illustrate an X axis, a Y axis and a Z axis orthogonal to each other. A direction along the X axis is referred to as a first direction X, a direction along the Y axis is referred to as a second direction Y and a direction along the Z axis is referred to as a third direction Z. Further, viewing the constitutional elements parallel to the Z direction is referred to as plan view.

In each embodiment, a highly transparent liquid crystal display device (so-called transparent display device) to which a polymer-dispersed liquid crystal is applied is disclosed as an example of a display device. Note here that the configuration disclosed in each embodiment can be applied to other types of display devices as well.

### First Embodiment

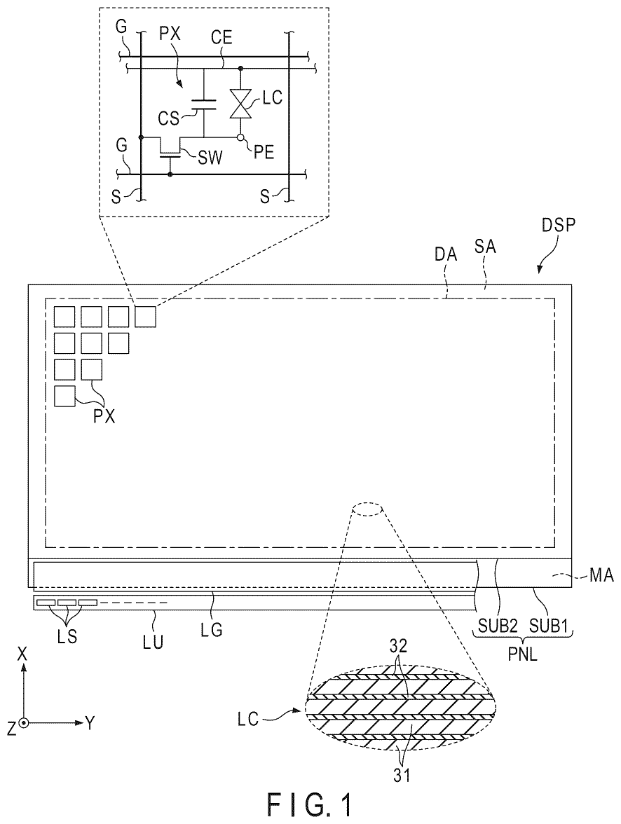

FIG. 1 is a diagram showing a configuration example of a display device DSP according to this embodiment. The display device DSP comprises a display panel PNL, a light source unit LU, and a light guide LG. In the example shown in FIG. 1, broken lines are added to the light source unit LU and the light guide LG to indicate parts of these components, which have been omitted from the illustration.

The display panel PNL comprises a first substrate SUB1 and a second substrate SUB2 stacked one on another along the third direction Z. In the example shown in FIG. 1, the shapes of the first substrate SUB1 and the second substrate SUB2 in plan view are rectangular shapes having long sides parallel to the second direction Y. Note here that the shapes of the first substrate SUB1 and the second substrate SUB2 are not limited to those of this example, but may be, for example, rectangular shapes having long sides parallel to the first direction X, circular shapes, or oval shapes.

The length of the first substrate SUB1 along the first direction X is greater than the length of the second substrate SUB2 along the first direction X. The first substrate SUB1 includes a mounting area MA formed in the portion protruding with respect to the second substrate SUB2 in a direction opposite to the first direction X. The mounting area MA corresponds to the region of the first substrate SUB1, which does not overlap the second substrate SUB2. On the mounting area MA, the integrated circuits and flexible circuit boards not shown in the figure are to be mounted.

The display panel PNL includes a display area DA which displays images and a frame-like peripheral area SA surrounding the display area DA. The display area DA and the peripheral area SA are both formed in the region where the first substrate SUB1 and the second substrate SUB2 overlap each other. The display area DA comprises a plurality of pixels PX arranged in a matrix pattern along the first direction X and the second direction Y.

The display panel PNL further comprises a liquid crystal layer LC sealed between the first substrate SUB1 and the second substrate SUB2. As shown in the enlarged schematic diagram in the lower part of FIG. 1, the liquid crystal layer LC is constituted by a polymer dispersion-type liquid crystal that contains polymers 31 and liquid crystal molecules 32.

In one example, the polymers 31 are liquid crystal polymers. The polymers 31 are formed into the shape of stripes elongated along the second direction Y and aligned along the first direction X. The liquid crystal molecules 32 are dispersed in the gaps of the polymers 31 and arranged so that their longitudinal axes are aligned along the second direction Y.

Each of the polymers 31 and liquid crystal molecules 32 has optical anisotropy or refractive index anisotropy. The responsiveness of the polymers 31 to an electric field is lower than the responsiveness of the liquid crystal molecules 32 to an electric field. In one example, the alignment direction of the polymers 31 does not substantially change regardless of the presence or absence of an electric field. In contrast, the alignment direction of the liquid crystal molecules 32 changes according to the voltage applied to the liquid crystal layer LC.

When no voltage is being applied to the liquid crystal layer LC, the optical axes of the polymer 31 and the liquid crystal molecules 32 are parallel to each other, and light that enters the liquid crystal layer LC passes therethrough without being substantially scattered (transparent state).

When voltage is being applied to the liquid crystal layer LC, the optical axes of the polymers 31 and liquid crystal molecules 32 intersect each other, and the light that enters the liquid crystal layer LC is scattered within the liquid crystal layer LC (scattered state).

As shown in the enlarged view in the upper part FIG. 1, a plurality of scanning lines G and a plurality of signal lines S are disposed on the display area DA. The scanning lines G extend in the second direction Y and are arranged along the first direction X. The signal lines S extend in the first direction X and are arranged along the second direction Y. The signal lines S intersect the scanning lines G.

Each pixel PX comprises a switching element SW, a pixel electrode PE, a common electrode CE, and a capacitor CS. The switching element SW is constituted, for example, by a thin-film transistor (TFT) and is electrically connected to the respective scanning line G and the respective signal line S. The pixel electrode PE is electrically connected to the respective switching element SW.

The liquid crystal layer LC (in particular, the liquid crystal molecules 32) is driven by the electric field generated between the pixel electrodes PE and the common electrode CE. The capacitor CS is formed, for example, between an electrode having the same potential as that of the common electrode CE and an electrode having the same potential as that of the pixel electrode PE.

The light source unit LU and the light guide LG are disposed along the mounting area MA. The light source unit LU comprises a plurality of light emitting elements LS arranged along the second direction Y. Each light emitting element LS irradiates light to the light guide LG. For the light guide LG, a lens such as a prism lens can be used.

For example, the light emitting elements LS may include light emitting elements that emit red light, light emitting elements that emit green light, and light emitting elements that emit blue light. These light emitting elements may be arranged along the second direction Y or stacked in the third direction Z. As the light emitting elements LS, light-emitting diodes (LEDs) may be used.

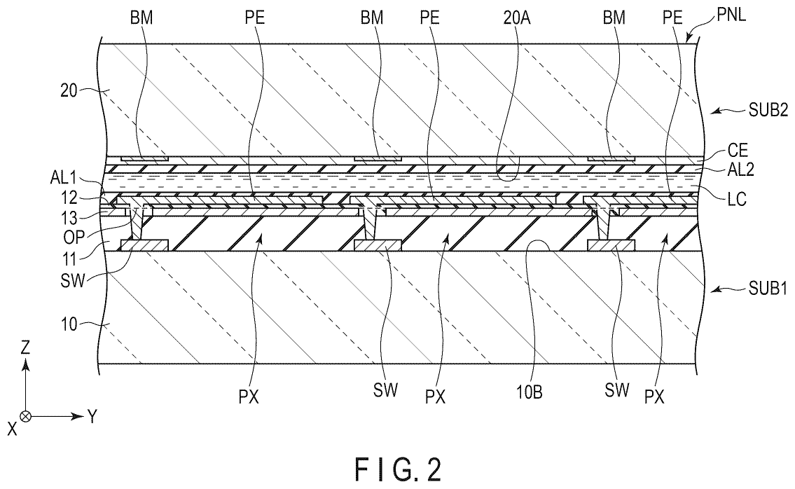

FIG. 2 is a schematic cross-sectional diagram showing a configuration example of the display panel PNL shown in FIG. 1. The first substrate SUB1 comprises a first transparent substrate 10, insulating films 11 and 12, capacitive electrodes 13, switching elements SW, pixel electrodes PE, and an alignment film AL1.

Although not shown in the illustration, the first substrate SUB1 further comprise the scanning lines G and signal lines S shown in FIG. 1. The switching elements SW are disposed on a main surface 10B of the first transparent substrate 10. The main surface 10B is the surface opposing the second substrate SUB2. The insulating film 11 covers the switching elements SW. The capacitive electrodes 13 are located between the insulating film 11 and the insulating film 12.

In the example shown, the insulating film 11 and the capacitive electrodes 13 are provided over the entire surface of each pixel PX, but such a configuration is not limited to that of this example. The insulating film 11 only needs to be arranged so as to cover at least the switching elements SW, the scanning lines G, and the signal lines S.

The capacitive electrodes 13 may be formed into a grid pattern along the scanning lines G and the signal lines S. The pixel electrode PE is disposed on the insulating film 12 for each pixel PX. The pixel electrode PE is electrically connected to the respective switching element SW via an aperture OP made in the respective capacitive electrode 13. The pixel electrode PE overlaps the respective capacitive electrode 13 while interposing the insulating film 12 therebetween, thereby forming the capacitor CS of the respective pixel PX. The alignment film AL1 covers the pixel electrodes PE.

The second substrate SUB2 comprises a second transparent substrate 20, light shielding layers BM, a common electrode CE, and an alignment film AL2. The second transparent substrate 20 opposes the first transparent substrate 10 along the third direction Z.

The light shielding layers BM and the common electrode CE are disposed on a main surface 20A of the second transparent substrate 20. The main surface 20A is the surface opposing the first transparent substrate 10. The light shielding layers BM are disposed, for example, directly above the switching elements SW, respectively, and directly above the scanning lines G and the signal lines S, respectively, which are not shown in the figure.

The common electrode CE opposes the pixel electrodes PE along the third direction Z while interposing the liquid crystal layer LC therebetween. The common electrode CE is disposed over multiple pixels PX and directly covers the light shielding layers BM. The common electrode CE is electrically connected to the capacitive electrodes 13 and has the same potential as that of the capacitive electrodes 13. The alignment film AL2 covers the common electrode CE.

The liquid crystal layer LC is located between the first transparent substrate 10 and the second transparent substrate 20, and is in contact with the alignment films AL1 and AL2. In the first substrate SUB1, the insulating film 11, the insulating film 12, the capacitive electrodes 13, the switching elements SW, the pixel electrodes PE, the alignment film AL1, the scanning lines G and the signal line S are located between the first transparent substrate 10 and the liquid crystal layer LC. In the second substrate SUB2, the light shielding layers BM, the common electrode CE and the alignment film AL2 are located between the second transparent substrate 20 and the liquid crystal layer LC.

The first transparent substrate 10 and the second transparent substrate 20 are insulating substrates such as glass substrates or plastic substrates. The insulating film 11 is formed of a transparent insulating material such as silicon oxide, silicon nitride, silicon oxynitride, and acrylic resin.

In one example, the insulating film 11 includes an inorganic insulating film and an organic insulating film. The insulating film 12 is an inorganic insulating film such as of silicon nitride. The capacitive electrodes 13, the pixel electrodes PE, and the common electrodes CE are transparent electrodes formed of transparent conductive materials such as indium tin oxide (ITO), indium zinc oxide (IZO) and the like. The light shielding layers BM are conductive layers having a resistance lower than that of the common electrode CE, for example.

In one example, the light-shielding layers BM is formed of an opaque metal material such as molybdenum, aluminum, tungsten, titanium, silver or the like. The alignment films AL1 and AL2 are horizontal alignment films that have alignment restriction force substantially parallel to the X-Y plane. In one example, the alignment films AL1 and AL2 are subjected to alignment treatment along the second direction Y. Note here that the alignment treatment may be a rubbing process or a photo-alignment process.

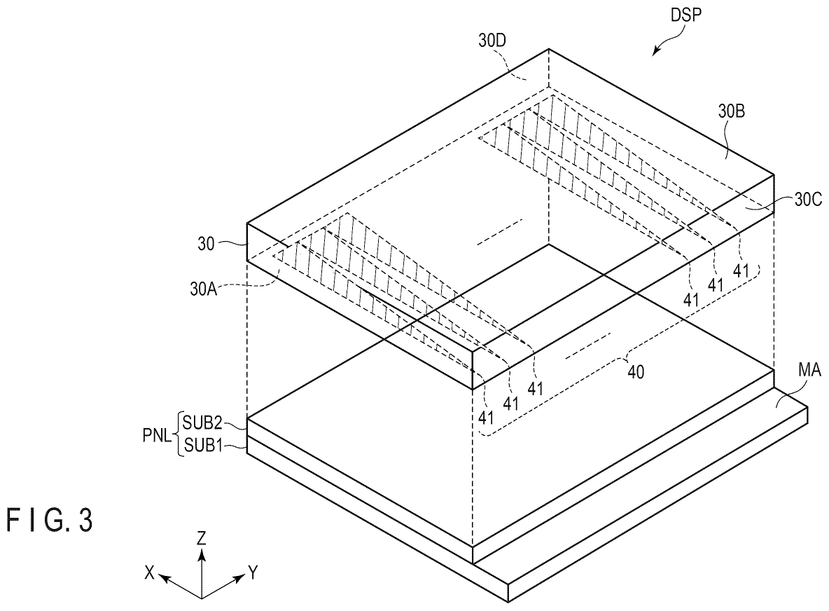

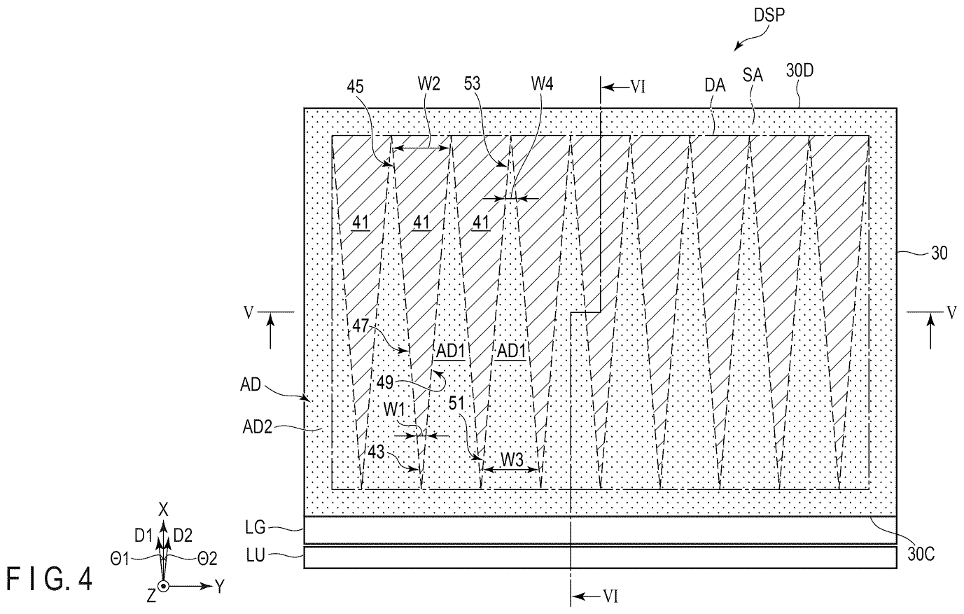

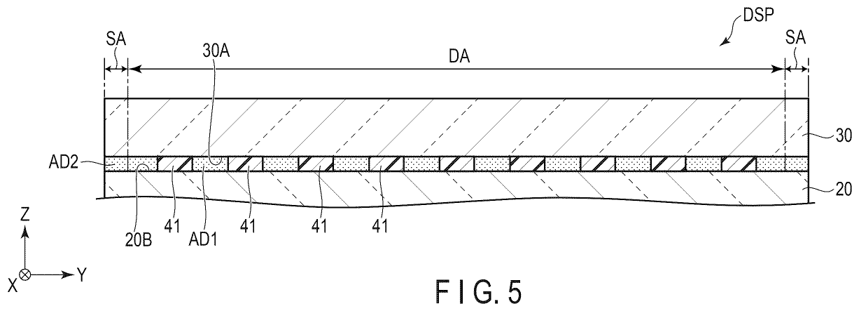

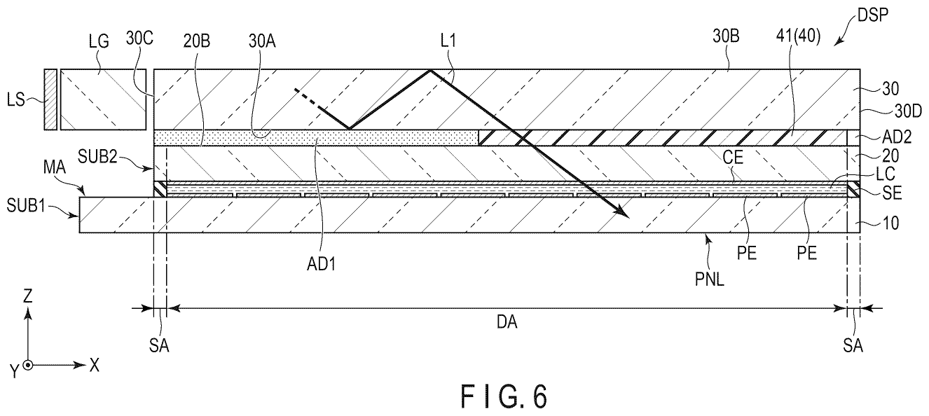

FIG. 3 is an exploded perspective view showing the main parts of the display device DSP of this embodiment. FIG. 4 is a plan view schematically showing the display device DSP shown in FIG. 3. FIG. 5 is a brief cross-sectional view taken along the line V-V shown in FIG. 4. FIG. 6 is a brief cross-sectional view taken along the line VI-VI shown in FIG. 4. Note that in each figure, the structure of the display panel PNL and the like is illustrated schematically, and some elements are omitted.

The display device DSP further comprises a third transparent substrate 30 and a transparent layer 40. In FIGS. 3 and 4, the transparent layer 40 is shown to be shaded. The first substrate SUB1, the second substrate SUB2, the transparent layer 40 and the third transparent substrate 30 are stacked in this order in the third direction Z.

The third transparent substrate 30 is formed in the shape of a flat plate. The third transparent substrate 30 is, for example, a glass substrate, but it may as well be an insulating substrate such as a plastic substrate. The size of the third transparent substrate 30 in plan view is equivalent to the size of the second substrate SUB2 in plan view.

The third transparent substrate 30 has a main surface 30A, a main surface 30B on an opposite side to the main surface 30A, and side surfaces 30C and 30D connecting the main surface 30A and the main surface 30B to each other. The side surface 30C corresponds to the first side surface, and the side surface 30D corresponds to the second side surface. The first direction X corresponds to the direction from the side surface 30C towards the side surface 30D.

The main surfaces 30A and 30B are parallel to the X-Y plane defined by the X axis and Y axis. The main surface 30A opposes the second substrate SUB2. The side surfaces 30C and 30D are parallel to the Y-Z plane defined by the Y axis and Z axis. The side surfaces 30C and 30D are arranged in this order along the first direction X.

The thickness of the third transparent substrate 30 is greater than the thickness of the first substrate SUB1 or the second substrate SUB2. Here, the thickness is the distance along the third direction Z. In one example, the third transparent substrate 30 has a thickness twice or more that of the first substrate SUB1 and the second substrate SUB2.

The transparent layer 40 is arranged between the display panel PNL and the third transparent substrate 30, as shown in FIG. 3. More specifically, the transparent layer 40 is disposed so as to overlap the display area DA in the main surface 30A of the third transparent substrate 30, as shown in FIG. 4.

The transparent layer 40 includes a plurality of strip portions 41. The plurality of strip portions 41 extend in the first direction X and are aligned along the second direction Y. Of the strip portions 41, each adjacent pair may be connected as shown in FIG. 3 or separated. The strip portions 41 have substantially the same shape. For example, the strip portions 41 have a triangular shape in plan view.

As shown in FIG. 4, the strip portion 41 has a first end portion 43 on a side surface 30C side, a second end portion 45 on an opposite side to the first end portion 43, a first edge 47, and a second edge 49. Here, each end portion includes the end and the region around the end.

The first edge 47 and the second edge 49 extend in directions different from the first direction X or the second direction Y. For example, a direction that intersects at an acute angle counterclockwise with respect to the first direction X is defined as a direction D1, whereas a direction that intersects at an acute angle clockwise with respect to the first direction X is defined as a direction D2.

Note here that the angle θ1 made by the first direction X and the direction D1 and the angle θ2 made by the first direction X and the direction D2 are the same as each other, but the configuration is not limited to that of this example. For example, the angle between the first direction X and the direction D1 may be different from the angle between the first direction X and the direction D2.

The first edge 47 extends along the direction D1, and the second edge 49 extends along the direction D2. Here, the length of the first edge 47 is the same as the length of the second edge 49. In the example shown in FIG. 4, the first edge 47 and the second edge 49 both extend in a straight line, but they may as well be formed in a curved shape.

As described above, the strip portions 41 have such a width that increases at a constant rate or at an arbitrary rate as it extends from the first end portion 43 towards the second end portion 45 along the first direction X. Here, the width is the distance along the second direction Y.

Now, the width of the first end portion 43 along the second direction Y is defined as a width W1, and the width of the second end portion 45 along the second direction Y is defined as a width W2. In the example shown in FIG. 4, the width W1 is less than the width W2 (W1<W2).

The transparent layer 40 is formed, for example, of silicon oxide (SiO). Note that the transparent layer 40 may as well be formed of some other material if it is possible to form a fine shape.

The display device DSP further comprises an adhesive layer AD disposed between the second transparent substrate 20 and the third transparent substrate 30, as shown in FIGS. 4 to 6. In FIG. 4, the adhesive layer AD is indicated by dotted parts.

The adhesive layer AD adheres the main surface 20B of the second transparent substrate 20 and the main surface 30A of the third transparent substrate 30 to each other. The adhesive layer AD is colorless and transparent, and is formed from, for example, optical clear resin (OCR), which is a liquid transparent adhesive that has been cured, but the material is not limited to that of this example.

In the example shown in FIG. 4, the adhesive layer AD has a size equivalent to the external dimensions of the third transparent substrate 30. As shown in FIG. 4, the adhesive layer AD has a plurality of first portions AD1 and a second portion AD2.

The plurality of first portions AD1 and the second portion AD2 are formed to be integrated as one body. The first portions AD1 overlap the display area DA, and the second portion AD2 overlaps the peripheral area SA. Each first portion AD1 is disposed between each respective pair of strip portions 41 adjacent to each other along the second direction Y.

In the space between each adjacent pair of strip portions 41, the first portion AD1 has a triangular shape, for example, in plan view. In other words, the first portion AD1 fills the space between each adjacent pair of strip portions 41. The second portion AD2 is formed into a frame-like shape that encloses the first portions AD1 and the strip portions 41. Further, the spaces between the strip portions 41 and the second portion AD2 as well are included in the first portions AD1, respectively.

The first portions AD1 each include a third end portion 51 between the first end portions 43 of the respective adjacent pair of strip portions 41, and a fourth end portion 53 between the second end portions 45 of the respective adjacent pair of strip portions 41. The third end portions 51 are each connected to a part of the second portion AD2, which is located on a side surface 30C side, for example, and the fourth end portions 53 are each connected to a part of the second portion AD2, which is located on a side surface 30D side, for example.

The first portions AD1 has such a width that decreases at a constant rate or at an arbitrary rate from the third end portion 51 towards the fourth end portion 53 along the first direction X. Here, the width of the third end portion 51 in the second direction Y is defined as a width W3, and the width of the fourth end portion 53 in the second direction Y is defined as a width W4. Note that the width W3 is greater than the width W4 (W3>W4).

Between each adjacent pair of strip portions 41, the adhesive layer AD, as shown in FIG. 5, is in contact with both the main surface 20B of the second transparent substrate 20 and the main surface 30A of the third transparent substrate 30. In addition, in the example shown in FIG. 5, the adhesive layer AD is not disposed between the strip portions 41 and the second transparent substrate 20. In other words, the strip portions 41 are in contact with the main surface 20B of the second transparent substrate 20. In this case, the adhesive layer AD (the first portions AD1 and the second portion AD2) has a thickness that is substantially equal to the width of the strip portions 41.

The display panel PNL further comprises a seal SE that adheres the first substrate SUB1 and the second substrate SUB2 together, as shown in FIG. 6. The seal SE surrounds the display area DA in plan view. The liquid crystal layer LC is sealed in the space surrounded by the seal SE. The second portion AD2 of the adhesive layer AD overlaps the seal SE in the third direction Z.

The refractive indices of the first transparent substrate 10, the second transparent substrate 20, the third transparent substrate 30 and the transparent layer 40 are equivalent to each other. Here, the expression “equivalent” does not only mean that the difference in refractive index is zero, but also includes cases where the difference in refractive index is 0.05 or less.

The refractive index of the adhesive layer AD is lower than the refractive indices of the first transparent substrate 10, the second transparent substrate 20, the third transparent substrate 30, and the transparent layer 40. In one example, the refractive indices of the first transparent substrate 10, the second transparent substrate 20, the third transparent substrate 30, and the transparent layer 40 are approximately 1.5, whereas the refractive index of the adhesive layer AD is approximately 1.3 to 1.4.

As shown in FIG. 6, the light emitting elements LS, the light guides LG, and the third transparent substrate 30 are arranged in this order in the first direction X. The light emitting elements LS irradiate light toward the side surface 30C. Since the light emitting elements LS and the light guides LG do not oppose the side surface 30C, the light irradiated from the light emitting elements LS hardly enters from the side surface 30C.

In the third transparent substrate 30, the side surface 30C side corresponds to the region close to the light emitting elements LS, and the side surface 30D side corresponds to the region distant from the light emitting elements LS. By forming the first portions AD1 of the adhesive layer AD in the manner described above, the area where the main surface 30A of the third transparent substrate 30 and the first portions AD1 are in contact is greater in the region closer to the light emitting elements LS and less in the region more distant from the light emitting elements LS.

Each region where the main surface 30A and the respective first portion AD1 overlap each other corresponds to the region where light that has entered the third transparent substrate 30 does not substantially enter the display panel PNL side. Each region where the main surface 30A and the respective strip portion 41 of the transparent layer 40 overlap each other corresponds to the region where light that has entered the third transparent substrate 30 can enter the display panel PNL side.

Next, the light emitted from the light emitting elements LS will be explained with reference to FIG. 6. The light emitted from the light emitting element LS is diffused to a suitable degree in the light guide LG and then enters the third transparent substrate 30 through the side surface 30C.

The light that enters the third transparent substrate 30 through the side surface 30C reaches the liquid crystal layer LC via the third transparent substrate 30. Note that as described above, the refractive index of the adhesive layer AD is lower than that of the third transparent substrate 30.

Therefore, of the light that enters the third transparent substrate 30, the portion that travels from the third transparent substrate 30 towards the first portion AD1 of the adhesive layer AD is reflected at the interface between the third transparent substrate 30 and the first portion AD1.

Further, the light that travels towards the main surface 30B is reflected at the interface between the main surface 30B of the third transparent substrate 30 and the air layer. The light travels through the interior of the third transparent substrate 30 while being reflected repeatedly in the region where the third transparent substrate 30 and the first portion AD1 overlap each other.

Furthermore, the light that travels towards the region where the third transparent substrate 30 and the strip portion 41 of the transparent layer 40 overlap each other, passes through the third transparent substrate 30 and enters the display panel PNL via the strip portion 41. The refractive index of the transparent layer 40 is equivalent to that of the third transparent substrate 30, and therefore light is not substantially reflected at the interface between the third transparent substrate 30 and the strip portion 41.

The area where the main surface 30A and the first portion AD1 of the adhesive layer AD are in contact with each other is larger in the region closer to the light emitting element LS (on the side surface 30C side) and less in the region further distant away from the light emitting element LS (on the side surface 30D side).

The light from the light emitting element LS tends to attenuate as the location is further away from the light emitting element LS. In this embodiment, the entering of light from the light emitting element LS to the display panel PNL is suppressed in the region close to the light emitting element LS, and the entering of light to the display panel PNL is promoted in the region distant away from the light emitting element LS. In other words, the light from the light emitting element LS is forwarded by the transparent layer 40 and the adhesive layer AD.

With this configuration, in the first direction X, the luminance in the display area DA can be made uniform, and the occurrence of non-uniformity in luminance can be suppressed. As a result, it becomes possible to suppress the deterioration of the display quality in the display device DSP.

As a comparative example, let us assume the case where a layer to suppress the entering of light to the display panel PNL side (which will be hereinafter referred to as a low-refraction layer) is formed of silicon nitride, on the main surface 30A of the third transparent substrate 30, using the photolithography method. Note here that the low-refraction layer has a refractive index that is lower than that of the third transparent substrate 30.

Here, in the case of the low-refraction layer, when the shape of the low-refraction layer is to be made fine in order to adjust the amount of light that enters the display panel PNL side, it is difficult to obtain the desired shape. This fact can be a factor of decreasing the uniformity in luminance.

By contrast, in the present embodiment, the first portion AD1 of the adhesive layer AD is formed between strip portions 41 of the transparent layer 40 that are adjacent to each other along the second direction Y. In other words, the shape of the first portion AD1 can be changed as appropriate according to the shape of the strip portion 41.

The transparent layer 40 is formed of silicon oxide, and therefore a fine shape can be formed as compared to the case where the low-refractive layer is formed of silicon nitride. With this configuration, a transparent layer 40 with a high-definition shape can be formed, and accordingly, a first portion AD1 with a high-definition shape can be formed. As a result, by appropriately adjusting the amount of light entering the display panel PNL side, it is possible to equalize the brightness in the display area DA.

The shape of the first portion AD1 is not limited to that of the example provided above, but may be any other shape. In other words, by appropriately changing the shape and size of the transparent layer 40, the shape and size of the first portion AD1 can be changed appropriately. In the display device DSP, for example, by changing the shape and size of the first portion AD1, the amount of light entering the display panel PNL side can be adjusted.

Note that in the region close to the light emitting element LS, light very slightly enters the display panel PNL, and actually light enters the display panel PNL from the transparent layer 40. The side surface 30D is covered by a reflective member that is not shown in the figure, for example.

With this configuration, the light that reaches the side surface 30D is scattered and reflected by the reflective member, and then the light travels through the interior of the third transparent substrate 30 in a direction opposite to the first direction X. With the reflective member thus provided, the leakage of light out of the side surface 30D is suppressed, and by reusing the light, the efficiency in utilization of light is improved.

According to the display device DSP configured as described above, it is possible to suppress a decrease in display quality. Note here that light that enters the liquid crystal layer LC where voltage is not being applied, passes through the liquid crystal layer LC without substantially being scattered. On the other hand, light that enters the liquid crystal layer LC where voltage is being applied, is scattered by the liquid crystal layer LC. In the display device DSP, images can be observed from the side of the third transparent substrate 30, and can be observed from the side of the first transparent substrate 10 as well.

The display device DSP is a so-called transparent display, and regardless of whether the display device DSP is observed from the side of the third transparent substrate 30 or the side of the first transparent substrate 10, it is possible to observe the background of the display device DSP via the display device DSP.

Next, other embodiments will be explained. For the parts of the configuration in the following embodiments that are not specifically mentioned, parts similar to those used in the first embodiment can be applied.

### Second Embodiment

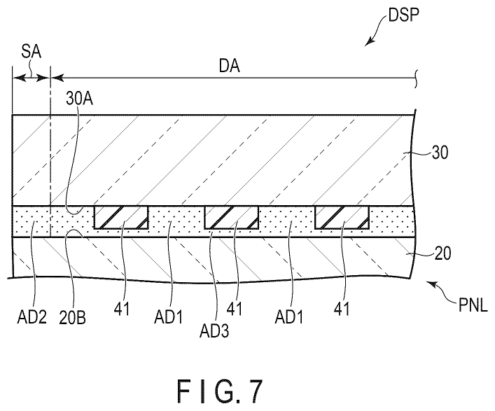

FIG. 7 is a partial cross-sectional view schematically showing a display device DSP in this embodiment. This embodiment is different from the first embodiment in that the adhesive layer AD is disposed between the transparent layer 40 and the second transparent substrate 20 as well.

The adhesive layer AD includes a further third portion AD3 disposed between the transparent layer 40 and the main surface 20B of the second transparent substrate 20. The third portion AD3 is connected to the first portions AD1. The thickness of the third portion AD3 is sufficiently less than the thickness of the first portions AD1. With this configuration, the refractive index of the third portion AD3 is higher than the refractive index of the first portions AD1.

By reducing the thickness of the third portion AD3, the refractive index of the third portion AD3 can be adjusted to be equivalent to the refractive index of the transparent layer 40. With this configuration, of the light that enters the third transparent substrate 30, the portion that travels towards the region where the strip portions 41 and the third portion AD3 overlap, passes through the strip portion 41 and enter the display panel PNL without being reflected at the third portion AD3.

With the configuration of this embodiment, advantageous effects similar to those of the first embodiment can be obtained.

### Third Embodiment

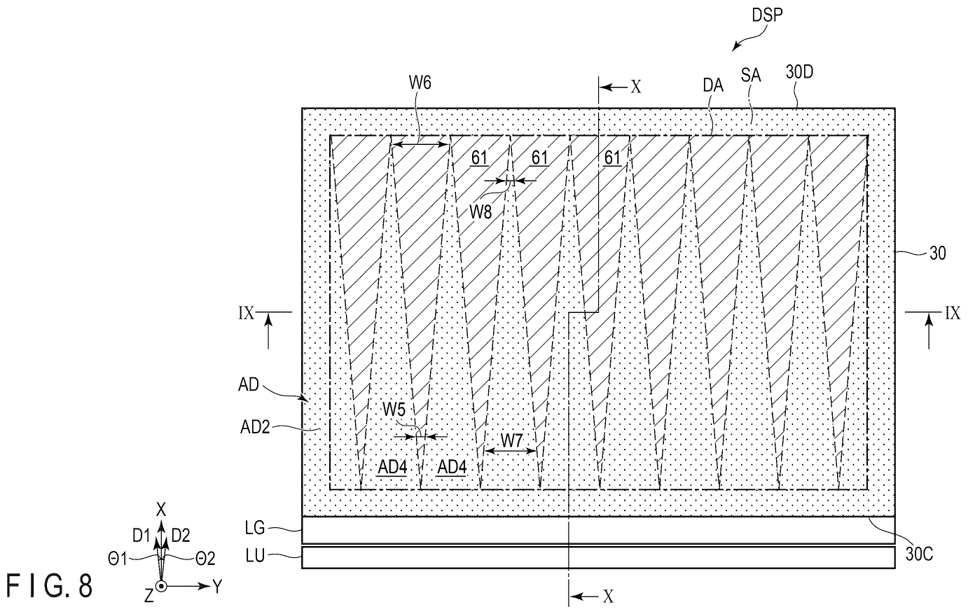

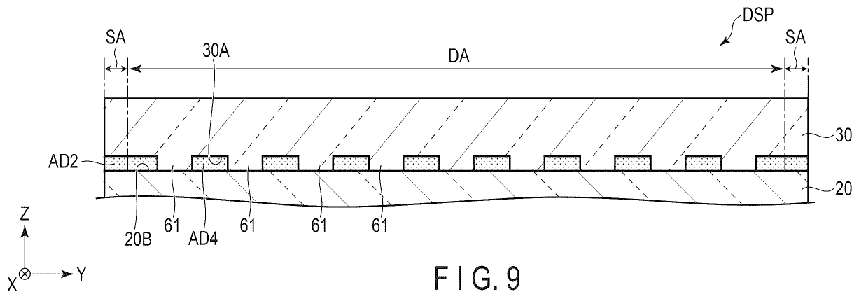

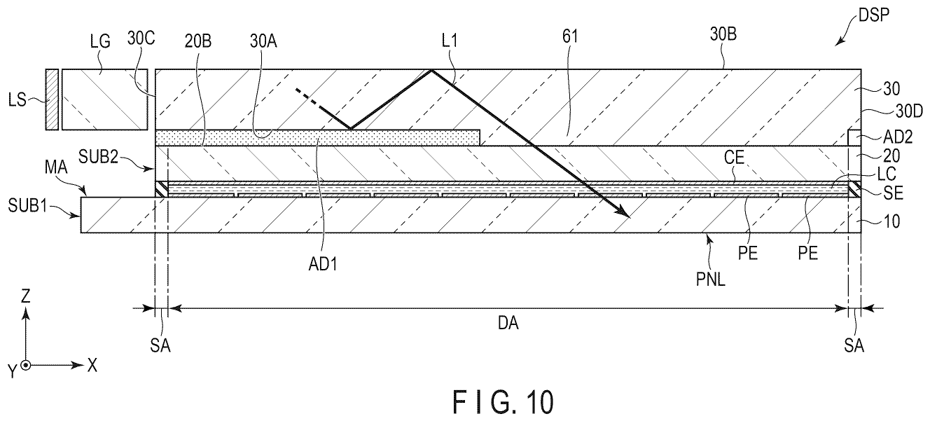

FIG. 8 is a plan view schematically showing a display device DSP of this embodiment. FIG. 9 is a schematic cross-sectional view taken along the line IX-IX shown in FIG. 8. FIG. 10 is a schematic cross-sectional view taken along the line X-X shown in FIG. 8. This embodiment is different from each of the embodiments provided above in that the third transparent substrate 30 includes a plurality of protrusions in place of the transparent layer 40.

The third transparent substrate 30 includes a plurality of protrusions 61 that protrude toward the display panel PNL on the main surface 30A. The plurality of protrusions 61 extend in the first direction X and are aligned along the second direction Y. These protrusions 61 have the same shape. The protrusions 61 have a shape similar to that of the strip portions 41 described in the first embodiment, for example.

Specifically, the protrusions 61 have such a width that increases at a constant rate or at an arbitrary rate along the first direction X. More specifically, the protrusions 61 have a width W5 along the second direction Y on the side surface 30C side, which is less than a width W6 of the protrusions 61 along the second direction Y on the side surface 30D side (W5<W6).

The adhesive layer AD has a plurality of fourth portions AD4, as shown in FIG. 8. Each fourth portion AD4 is disposed between the respective pair of protrusions 61, adjacent to each other along the second direction Y and between the respective protrusions 61 and the second portion AD2 as well.

The fourth portions AD4 and the second portion AD2 are formed to be integrated as one body. The fourth portions AD4 overlap the display area DA. The fourth portions AD4 have such a width that decreases at a constant rate or at an arbitrary rate along the first direction X. Specifically, the fourth portions AD4 have a width W7 along the second direction Y on the side surface 30C side, which is greater than a width W8 of the fourth portions AD4 along the second direction Y on the side surface 30D side (W7>W8).

As shown in FIG. 9, between each adjacent pair of protrusions 61, the respective fourth portion AD4 of the adhesive layer AD is in contact with both the main surface 20B of the second transparent substrate 20 and the main surface 30A of the third transparent substrate 30. Further, in the example shown in FIG. 9, the adhesive layer AD is not provided between the protrusions 61 and the second transparent substrate 20. In other words, the protrusions 61 are in contact with the main surface 20B of the second transparent substrate 20. In this case, the adhesive layer AD (fourth portions AD4) has a thickness that is substantially equal to that of the protrusions 61.

With the configuration of this embodiment as well, advantageous effects similar to those of the first embodiment can be obtained. With the fourth portions AD4 of the adhesive layer AD configured as described above, the area where the main surface 30A of the third transparent substrate 30 and the fourth portion AD4 are in contact with each other is greater in the region closer to the light emitting elements LS, and less in the region further distant away from the light emitting elements LS.

The region where the main surface 30A and the fourth portions AD4 overlap corresponds to the region where light that has entered the third transparent substrate 30 does not substantially enters the display panel PNL side. The region where the protrusions 61 and the main surface 20B of the second transparent substrate 20 overlap corresponds to the region where light that has entered the third transparent substrate 30 can enter the display panel PNL side.

The area where the main surface 30A and the fourth portions AD4 are in contact with each other is larger in the region closer to the light emitting elements LS (side surface 30C side) and less in the region further distant away from the light emitting elements LS (side surface 30D side).

With this configuration, in the region close to the light emitting elements LS, the entering of light from the light emitting element LS into the display panel PNL is suppressed. On the other hand, in the region that is further distant from the light emitting elements LS, the entering of light into the display panel PNL is promoted. Thus, in the first direction X, the luminance can be made uniform, and the occurrence of non-uniformity in luminance can be suppressed.

### Fourth Embodiment

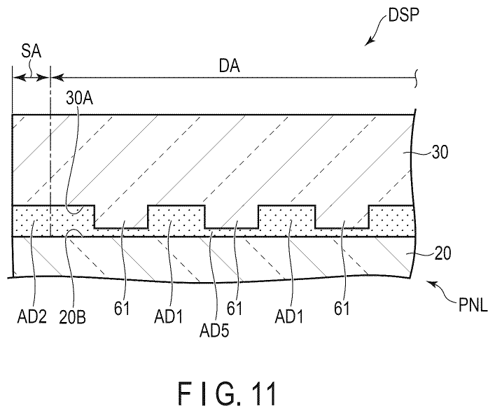

FIG. 11 is a partial cross-sectional view schematically showing a display device DSP of this embodiment. This embodiment is different from the third embodiment in that the adhesive layer AD is provided between the protrusions 61 and the second transparent substrate 20 as well.

The adhesive layer AD further includes a fifth portion AD5, which is located between the protrusions 61 and the main surface 20B of the second transparent substrate 20. The fifth portion AD5 is connected to the first portions AD1. The thickness of the fifth portion AD5 is sufficiently less than the thickness of the fourth portion AD4. With this configuration, the refractive index of the fifth portion AD5 is higher than the refractive index of the fourth portion AD4.

By reducing the thickness of the fifth portion AD5, the refractive index of the fifth portion AD5 can be adjusted to be equivalent to the refractive index of the protrusions 61. As a result, of the light that enters the third transparent substrate 30, the portion that travels towards the region where the protrusions 61 and the fifth portion AD5 of the adhesive layer AD overlap, can pass through the protrusion 61 and enter the display panel PNL without being reflected at the fifth portion AD5.

With the configuration of this embodiment as well, advantageous effects similar to those of the third embodiment can be obtained.

In addition, in each of the embodiments provided above, a light source unit may be further provided. The light source unit irradiates light towards the side surface 30D, for example. In such a case, the shape of the strip portions 41 of the transparent layer 40 and the protrusions can also be changed as appropriate.

Note that the display device DSP may further comprise a transparent cover member that is stacked on the first transparent substrate 10 from the opposite side of the third transparent substrate 30. In other words, the display panel PNL may be sandwiched between the third transparent substrate 30 and the cover member. The cover member is an insulating substrate such as a glass substrate or a plastic substrate.

Based on the display devices described above as embodiments of the invention, a person having ordinary skill in the art may achieve display devices with arbitral design changes; however, as long as they fall within the scope and spirit of the present invention, all of such display devices are encompassed by the scope of the present invention. A skilled person would conceive various changes and modifications of the present invention within the scope of the technical concept of the invention, and naturally, such changes and modifications are encompassed by the scope of the present invention. For example, if a skilled person adds/deletes/alters a structural element or design to/from/in the above-described embodiments, or adds/deletes/alters a step or a condition to/from/in the above-described embodiment, as long as they fall within the scope and spirit of the present invention, such addition, deletion, and altercation are encompassed by the scope of the present invention.

Furthermore, regarding the present embodiments, any advantage and effect those will be obvious from the description of the specification or arbitrarily conceived by a skilled person are naturally considered achievable by the present invention.

What is claimed is:

1. A display device comprising:
a display panel which displays images;
a transparent substrate including a main surface opposing the display panel and a first side surface connected to the main surface;
a light source unit which irradiates light toward the first side surface; and
an adhesive layer which adheres the display panel and the transparent substrate to each other and has a refractive index lower than that of the transparent substrate.

2. The display device of claim 1, wherein
the adhesive layer is formed by curing a liquid transparent adhesive.

3. The display device of claim 1, further comprising:
a transparent layer disposed between the display panel and the transparent substrate and having a refractive index equivalent to that of the transparent substrate,
wherein
the transparent substrate further includes a second side surface on an opposite side to the first side surface,
the transparent layer includes a plurality of tripe portions which extend in a first direction from the first side surface to the second side surface, and arranged along a second direction perpendicular to the first direction, and
the adhesive layer includes first portions each disposed between a respective pair of the strip portions adjacent to each other along the second direction.

4. The display device of claim 3, wherein
a width of the strip portions on a first side surface side along the second direction is less than a width of the strip portions on a second side surface side along the second direction, and a width of the first portions on the first side surface side along the second direction is greater than a width of the first portions on the second side surface side along the second direction.

5. The display device of claim 3, wherein
the transparent layer is in contact with the display panel.

6. The display device of claim 3, wherein
the display panel includes a display area which displays images and a peripheral area which surrounds the display area, and
the adhesive layer further includes a second portion which surrounds the first portion and overlaps the peripheral area.

7. The display device of claim 6, wherein
the second portion is connected to the first portions.

8. The display device of claim 3, wherein
the adhesive layer further includes a third portion disposed between the transparent layer and the display panel, and
a thickness of the third portion is less than the thickness of the first portions.

9. The display device of claim 3, wherein
the transparent layer is formed of silicon oxide.

10. The display device of claim 1, wherein
the transparent substrate includes a second side surface on an opposite side to the first side surface, and a plurality of protrusions which protrude from the main surface towards display panel, extend in a first direction from the first side surface towards the second side surface and are arranged in a second direction that is orthogonal to the first direction, and
the adhesive layer includes fourth portions each disposed between a respective pair of the protrusions adjacent to each other along the second direction.

11. The display device of claim 10, wherein
a width of the protrusions on a first side surface side along the second direction is less than a width of the protrusions on a second side surface side along the second direction, and
a width of the fourth portions on a first side surface side along the second direction is greater than a width of the fourth portions on a second side surface side along the second direction.

12. The display device of claim 10, wherein
the plurality of protrusions are in contact with the display panel.

13. The display device of claim 10, wherein
the adhesive layer further includes fifth portions disposed between the protrusions and the display panel, respectively, and
a thickness of the fifth portions is less than a thickness of the fourth portions.

14. The display device of claim 10, wherein
the transparent substrate is a glass substrate.

15. The display device of claim 5, wherein
a thickness of the first portions is substantially equal to a thickness of the strip portions.

16. The display device of claim 8, wherein
a refractive index of the third portion is higher than a refractive index of the first portions.

17. The display device of claim 12, wherein
a thickness of the fourth portions is substantially equal to a thickness of the protrusions.

18. The display device of claim 13, wherein
a refractive index of the fifth portion is higher than a refractive index of the fourth portions.

19. The display device of claim 1, wherein
the display panel contains a polymer dispersed liquid crystal.
